(19) United States
(12) Patent Application Publication
(10) Pub. No.: US 2012/0202522 A1
(43) Pub. Date: Aug. 9, 2012

(54) Methods and Means for Identifying and for Locating Entities Meeting Criteria

(76) Inventor: Alfred M. Haas, Oakhurst, NJ (US)

(21) Appl. No.: 13/362,802

(22) Filed: Jan. 31, 2012

Related U.S. Application Data
(60) Provisional application No. 61/437,695, filed on Jan. 31, 2011.

(51) Int. Cl. H04W 4/02

(52) U.S. Cl. 455/456.2

(57) ABSTRACT

This invention pertains to methods and means for identifying and/or locating entities that meet certain criteria. Various embodiments of the methods and means of the invention may be performed by and/or implemented in hardware, in software, by one or more entities, and/or by some combination of hardware, software and/or one or more entities.

### CROSS-REFERENCE TO RELATED APPLICATIONS

Pursuant to 35 USC §119(e) and as set forth in the Application Data Sheet, this utility application claims the benefit of priority from U.S. Provisional Patent Application No. 61/437,695 (“the '695 provisional”) which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention claims priority from the '695 provisional and expressly incorporates by reference the disclosures contained therein, including but not limited to all patents, patent applications, and publications which are incorporated by reference in the '695 provisional and which are incorporated by reference herein in their entirety.

In the context of the instant disclosure, the term “software” is taken in the broadest sense of its ordinary meaning and may comprise, but is not limited to, one or more of the following: realized embodiments of algorithms in any form, code written in whole or in part in any programming, scripting or other language (including, but not limited to, popular languages such as C++, Java, Visual Basic, Python, PHP, HTML, and/or device specific machine or assembly languages, etc . . . ), programs, mobile and/or other applications (e.g., those for Android and iOS based systems), applets, scripts, operating systems (OS) and components of OS, embedded and other software and instructions, structured data, op codes, commands, executables, firmware, drivers, virtual machines, and/or instruction sets for a system, etc . . . Software may operate at many levels including, but not limited to, over a distributed system (e.g., on a cloud computing or mobile network), on a particular device, on a local computer or other machine, embedded in an ASIC or other circuit, and running on top of one or more real or virtual levels, including but not limited to an OS and a hardware level.

In the context of the instant disclosure, hardware is taken in the broadest sense of its ordinary meaning and may comprise, but is not limited to, one or more of the following: smart and other scales, thermostats, e-readers (e.g. Kindle™ and Nook™), hearing aids, laptop and desktop computers, home alarms, smart phones, PDAs, other commercially available electronic devices such as tablet PCs, netbooks, e-readers, pagers, beepers, cell phones, hearing aids, watches comprising integrated and/or discrete circuits, monitors and displays, televisions, calculators, iPods™ and MP3 players, radios and stereos, speakers, microphones, remote controls, bar code readers, keyboards, cameras, other input devices, data acquisition systems, other physical devices and systems comprising integrated and/or discrete circuits, CPUs, hard drives, flash USB drives, other flash and solid state drives, programmable logic arrays, FPGAs, CPLDs, microcontrollers, digital signal processors, memories receivers, transmitters, drivers, ADC's (analog-to-digital converters), DAC's (digital-to-analog converters), decoders, multiplexers, comparators, latches, gates, op amps, LNA (low noise amplifiers), PLL (phase locked loops), antennae, coils, radio frequency identification (“RFID”) devices, near-field communication (“NFC”) devices, capacitors, inductors, resistors, transformers, solenoids, other analog circuits and components, other digital circuits and components, other mixed-signal circuits and components, optical circuits, other electromagnetic circuits and components, biological and/or chemical circuits, assemblies of memristors, carbon nanotubes, etc . . . .

Some embodiments of the methods and means of the instant invention may employ one or more existing wireless and/or wired communication protocols, or other custom protocols. Illustrative examples of current and historical protocols, programs and standards for digital communication include: the Internet Protocol Suite; e-mail protocols such as POP (Post Office Protocol), SMTP (Simple Mail Transfer Protocol), IMAP (Internet Message Access Protocol), and MAPI (Messaging Application Programming Interface); web browsers such as Safari™, Internet Explorer™ and Firefox™; messaging programs, protocols and standards such as WLM (Windows Live Messenger), MSNP (Microsoft Notification Protocol), AIM (AOL Instant Messenger), ICQ, XMPP (Extensible Messaging and Presence Protocol), IRC (Internet Relay Chat), MIM (Mobile Instant Messaging), SMS (Short Message Service), WAP (Wireless Area Protocol), GPRS (General Packet Radio Service), WLAN (Wireless Local Area Network), Bluetooth™, and Skype™; mobile standards such as GSM (Global System for Wideband Communications), W-CDMA (Wideband Code Division Multiple Access), LTE (Long Term Evolution), and LTE-Advanced, WirelessMAN (Metropolitan Area Networks)-Advanced; NFC (near-field communications), and many others not addressed here. To the extent that documented versions of these protocols, programs and standards are publicly accessible they are incorporated herein by reference. Likewise, some embodiments of the methods and/or means of the instant invention may employ analog and/or mixed-signal methods of communicating data or information. In addition, some embodiments of the invention employ GPS (Global Positioning System) and aGPS (Assisted Global Positioning System) protocols and/or standards.

The discussion of the background of the invention herein is included to explain the context of the invention. Although each of the patents, patent applications, and publications cited herein are hereby incorporated by reference, neither the discussion of the background nor the incorporation by reference is to be taken as an admission that any aspect, element, embodiment, or feature of the invention was published, known, or part of the common general knowledge as of the priority date of any claims of the invention.

### BRIEF SUMMARY OF THE INVENTION

This invention pertains to methods and means for identifying and/or locating entities that meet certain criteria. Various embodiments of the methods and means of the invention may be performed by and/or implemented in hardware, in software, by one or more entities, and/or by some combination of hardware, software and/or one or more entities. In one specific example of an embodiment, means for identifying and/or locating entities that meet certain criteria may comprise a cellular telephone (“cell phone”).

### BRIEF DESCRIPTION OF THE SEVERAL VIEWS OF THE DRAWING

FIG. 1 is a schematic representation illustrating several examples of embodiments of methods and means for identifying and for locating entities that meet certain criteria.

### DETAILED DESCRIPTION OF THE INVENTION

This invention comprises methods and means for identifying and/or locating entities that meet certain criteria. In some embodiments, means for identifying and/or locating entities that meet certain criteria may comprise some combination of hardware and/or software.

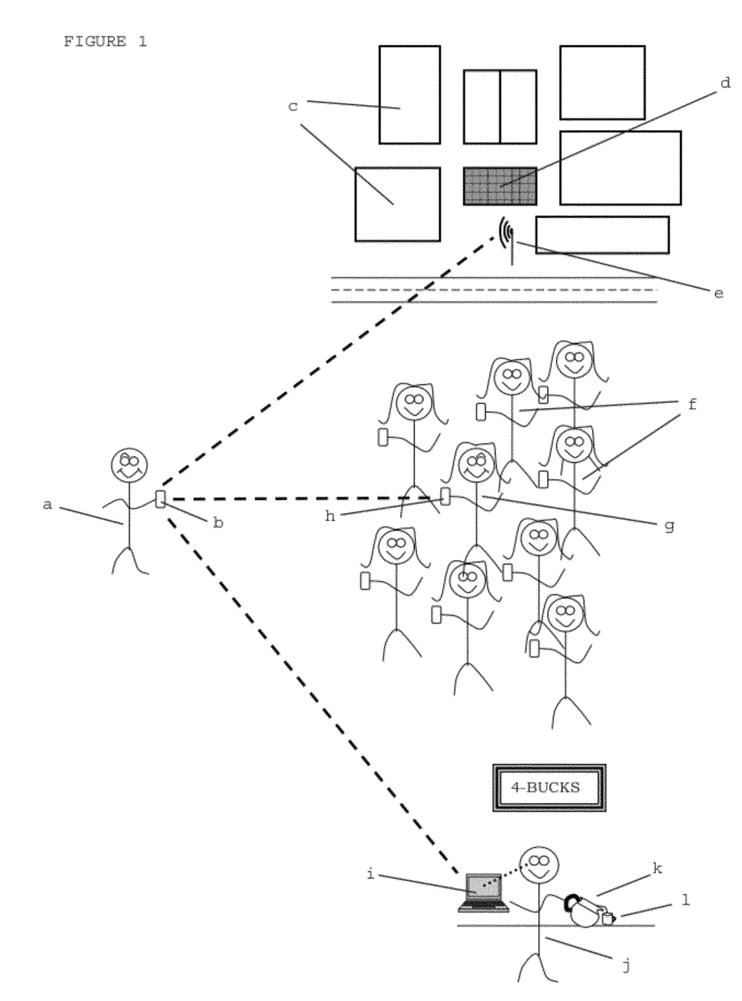

Although it is not believed that drawings are necessary for the understanding of the subject matter sought to be patented, for illustrative purposes we have included a figure related to specific examples of embodiments of the disclosed invention. FIG. 1 is a schematic diagram illustrating three separate examples of embodiments of methods and means for identifying and for locating entities that meet certain criteria. In the first example, a user, (a), employs cell phone, (b), to communicate with a transceiver in communications module, (e), to ascertain the location of an entity comprising a particular establishment, (d), meeting certain criteria—e.g. that they sell men's shoes—where the establishment is part of a shopping mall comprising buildings, (c) and (d). It should be noted that the dotted lines between cell phone, (b), and hardware comprising, (e) (and also between (b) and the hardware comprising (h), and (i)) are not intended to represent the actual signal path of communications between the cell phone and the respective hardware; for example, although some communications may be direct, e.g. when scanning some bar codes or RFID tags, other communications may involve one or more intermediate pathways, including for example but not limited to transmissions to and from a cell tower, over a land line, by satellite, etc . . . . The dotted lines in the illustration are not intended to limit the invention in any way. In the second example illustrated in FIG. 1, user, (a), employs cell phone, (b), to find a compatible entity comprising a woman, (g), carrying her own cell phone, (h), amongst a crowd of other less compatible women, (f). In this specific example, the cell phones may communicate through a wireless and/or wired network and/or directly with one another; compatibility in this specific example is assessed via correlating previously specified user criteria, with sensed and/or received data. In the third example shown in FIG. 1, a user comprising a barista, (j), at the local “4-BUCKS” coffeehouse identifies an entity comprising a customer, (a), when the barista's computer, (i), detects that the customer's cell phone, (b), inside the coffee house. In this specific example, the user may pre-loaded his coffee order onto the 4-BUCKS website using an application on his cell phone, so that when he enters the establishment and his cell phone is detected, the order is automatically communicated to the barista who prepares the customer's coffee, (l), in this specific case by pouring it from coffee pot, (k). It should be noted that the figures and examples they represent are provided for illustrative purposes only and are not intended to limit the scope of the instant invention.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. A means comprising hardware for identifying an entity which meets one or more criteria.

2. The means of claim 1, wherein the hardware comprises one or more of a cell phone, a tablet computer and a personal digital assistant.

3. A means comprising hardware for locating an entity which meets one or more criteria.

4. The means of claim 3, wherein the hardware comprises one or more of a cell phone, a tablet computer and a personal digital assistant.

5. A method for identifying entities that meet one or more criteria comprising the steps of specifying one or more criteria and invoking a means for identifying entities who meet the criteria.

6. A method for locating entities that meet one or more criteria comprising the steps of specifying one or more criteria and invoking a means for locating entities who meet the criteria.
